(19) United States
(12) Patent Application Publication
(10) Pub. No.: US 2015/0319765 A1
(43) Pub. Date: Nov. 5, 2015

(54) METHODS AND APPARATUSES OF ALLOCATING RESOURCES FOR DEVICE-TO-DEVICE COMMUNICATION

(71) Applicant: NEC (CHINA) CO., LTD., Beijing (CN)

(72) Inventors: Dalin ZHU, Beijing (CN); Ming LEI, Beijing (CN); Lingyang SONG, Beijing (CN); Chen XU, Beijing (CN); Hui LI, Beijing (CN)

(73) Assignee: NEC (CHINA) CO., LTD., Beijing (CN)

(21) Appl. No.: 14/650,776

(22) PCT Filed: Dec. 10, 2012
(86) PCT No.: PCT/CN2012/086303

§ 371 Date: Jun. 9, 2015

(51) Int. Cl. H04W 72/06; H04W 74/00; H04W 76/02; H04W 28/16; H04L 1/00

(52) U.S. Cl. CPC H04W 72/06; H04W 28/16; H04L 1/0001; H04W 76/02; H04W 74/002; H04W 88/02

(57) ABSTRACT

The present disclosure provides a method and an apparatus for allocating resources for device-to-device communication. The method may comprise selecting, from device-to-device pairs that need to be allocated resources and are sorted based on channel condition in descending order, a device-to-device pair ranking first in the device-to-device pairs; determining system sum rates for channels if the device-to-device pair shares resources with respective potential cellular users; and allocating resources assigned to a cellular user to the device-to-device pair based on the determined system sum rates. With embodiments of the present disclosure, the performance of the D2D communication may be further improved and it may achieve a system performance optimization.

### FIELD OF THE INVENTION

Embodiments of the present disclosure generally relate to a field of wireless communication technology, and more particularly, to methods and apparatuses of allocating resources for device-to-device communication.

### BACKGROUND OF THE INVENTION

Nowadays, the demand of high-speed data services to wireless bandwidths grows constantly, which has promoted various new technologies to be developed. For example, Device-to-Device (D2D) communication has been proposed to be an underlay to a cellular network so as to improve spectrum efficiency and system sum rate. The D2D communication is a new type of technology that allows user equipments (UEs) to communicate with each other through a direction connection instead of a base station and it is expected to become a key feature to be supported by next generation cellular networks. In the D2D communication, the D2D UEs could share same subcarrier resources with the conventional cellular UEs while the setup process will be still controlled by the network. In such way, it may provide a higher date rate, cost less power consumption, and lead to efficient resource (such as spectrum) utilization.

Although the D2D communication could bring great benefits to the wireless communication system, it may cause undesirable interference to the cellular network users due to spectrum sharing. During the downlink (DL) transmission, conventional cell UE may suffer from interference by a D2D transmitter, and on the other hand, during the uplink (UL) transmission, an eNode B (eNB) may be a victim of interference by the D2D transmitter when radio resources are allocated randomly. Therefore, in order to ensure that D2D communication is utilized efficiently, it usually requires employing resource management technology.

In Article “Efficient resource allocation for device-to-device communication underlaying LTE network,” M. Zulhasnine, C. Huang, and A. Srinivasan, IEEE 6th International Conference on Wireless and Mobile Computing, Networking and Communications, October 2010, there is proposed a resource allocation scheme. For an illustration purpose, FIGS. 1A and 1B has illustrated algorithms for downlink D2D RB allocation scheme and uplink D2D RB allocation scheme. According to the proposed resource allocation scheme, a UE with higher channel quality indicator (CQI) can share resource blocks (RBs) assigned thereto with a D2D transmitter with lower channel gain between them. Specifically, as illustrated in FIGS. 1A and 1B, CQIs for all UEs are sorted in descending order and in this order, a D2D transmitter d for which channel gain is minimum will be found from transmitters of D2D connections that need to be assigned RBs, and the RBs of the UE will be allocated to the D2D connection if SINRs of both the UE and the D2D pair (for the downlink transmission) or of both the D2D pair and the eNB (for the uplink transmission) are not less than respective target values. In such a way, RBs assigned to any UE with a higher CQI will be allocated to a D2D transmitter with a lower channel gain therebetween so as to share resources. In view of the fact that, during, for example, the downlink transmission, a high value of SINR would facilitate the increasing of throughput and the lower channel gain between the cellular UE and D2D transmitter will cause less interference to the UE, it seems that the proposed resource allocation scheme is a feasible resource management solution.

However, data service requirements are constantly increasing and it can not meet the requirements yet. Therefore, there is a need for a new technical solution for resource management in the art.

### SUMMARY OF THE INVENTION

In view of the foregoing, the present disclosure provides a new solution for power control so as to solve or at least partially mitigate at least a part of problems in the prior art.

According to a first aspect of the present disclosure, there is provided a method of allocating resources for device-to-device communication. The method may comprise: selecting, from device-to-device pairs that need to be allocated resources and are sorted based on channel condition in descending order, a device-to-device pair ranking first in the device-to-device pairs; determining system sum rates for channels if the device-to-device pair shares resources with respective potential cellular users; and allocating resources assigned to a cellular user to the device-to-device pair based on the determined system sum rates.

In an embodiment of the present disclosure, the determining system sum rates for respective channels may comprise, for each cellular user of the respective potential cellular users: determining a channel rate if the device-to-device pair share resources with the each cellular user; and summing up the determined channel rate and channel rates for other cellular users than the each cellular user, as the system sum rate if the device-to-device pair shares resources with the each cellular user.

In another embodiment of the present disclosure, the allocating resources may comprise: obtaining a maximum value in the determined system sum rates; and allocating resources assigned to a cellular user corresponding to the maximum value to the device-to-device pair.

In a further embodiment of the present disclosure, the channel condition may be represented by any one of channel rate at a current time interval; signal noise ratio at the current time interval; path loss at the current time interval; and path gain at the current time interval.

In a still further embodiment of the present disclosure, the channel condition may be represented by channel quality at a current time interval and channel rate obtained at a previous time interval.

In a yet further embodiment of the present disclosure, the channel condition may be represented by a factor W_{d}^{T}:

$${W}_{d}^{T} = \frac{{log}_{2} ( 1 + {P}_{d} {h}_{dd}^{2} / {N}_{0} )}{{\sum }_{t = 1}^{T - 1} {R}_{d}^{t}}$$

wherein T denotes an index of current time interval; d denotes an index of the device-to-device pair; P_{d} denotes transmit power of a transmitter in the device-to-device pair; h_{dd} denotes a channel response from the transmitter to the receiver of the device-to-device pair; N₀ denotes the thermal noise power; R_{d}^{t} denotes channel rate of the device-to-device pair d at the previous time interval t.

According to a second aspect of the present disclosure, there is further provided a method of allocating resources for device-to-device communication. The method may comprise: determining share channel rates for channels if each device-to-device pair shares resources with the respective potential cellular users; determining non-share channel rates for channels if the each device-to-device pair does not share resources with the respective potential cellular users; determining, for the each device-to-device pair, rate differences between the share channel rates and corresponding non-share channel rates; and allocating resources assigned to a cellular user to a device-to-device pair based on the rate differences for the each device-to-device.

According to a third aspect of the present disclosure, there is provided an apparatus for allocating resources for device-to-device communication. The apparatus may comprise: communication pair selection module configured to select, from device-to-device pairs that need to be allocated resources and are sorted based on channel condition in descending order, a device-to-device pair ranking first in the device-to-device pairs; sum rate determination module configured to determine system sum rates for channels if the device-to-device pair shares resources with respective potential cellular users; and resource allocation module configured to allocate resources assigned to a cellular user to the device-to-device pair based on the determined system sum rates.

According to a fourth aspect of the present disclosure, there is further provided an apparatus of allocating resources for device-to-device communication. The apparatus may comprise: share channel rate determination module configured to determine share channel rates for channels if each device-to-device pair shares resources with the respective potential cellular users; non-share channel rate determination module configured to determine non-share channel rates for channels if the each device-to-device pair does not share resources with the respective potential cellular users; rate difference determination module configured to determine, for the each device-to-device pair, rate differences between the share channel rates and corresponding non-share channel rates; and resource allocation module, configured to allocate resources assigned to a cellular user to a device-to-device pair based on the rate differences for the each device-to-device pair.

According to a fifth aspect of the present disclosure, there is provided a network node comprising the apparatus according to the third aspect.

According to a sixth aspect of the present disclosure, there is provided a network node comprising the apparatus according to the fourth aspect.

According to a seventh aspect of the present disclosure, there is provided a computer-readable storage media with computer program code embodied thereon, the computer program code configured to, when executed, cause an apparatus to perform actions in the method according to any one of embodiments of the first aspect.

According to a eighth aspect of the present disclosure, there is provided a computer-readable storage media with computer program code embodied thereon, the computer program code configured to, when executed, cause an apparatus to perform actions in the method according to any one of embodiments of the second aspect.

According to a ninth aspect of the present disclosure, there is provided a computer program product comprising a computer-readable storage media according to the seventh aspect.

According to a ten aspect of the present disclosure, there is provided a computer program product comprising a computer-readable storage media according to the eighth aspect.

With embodiments of the present disclosure, the performance of the D2D communication may be further improved and it may achieve a system performance optimization.

### BRIEF DESCRIPTION OF THE DRAWINGS

The above and other features of the present disclosure will become more apparent through detailed explanation on the embodiments as illustrated in the embodiments with reference to the accompanying drawings throughout which like reference numbers represent same or similar components and wherein:

FIGS. 1A and 1B schematically illustrates algorithms for downlink D2D RB allocation scheme and uplink D2D RB allocation scheme according to a solution in the prior art;

FIG. 2 schematically illustrates a system model of D2D communication underlying cellular networks in a case of downlink resource sharing;

FIG. 3 schematically illustrates a flow chart of a method of allocating resources for D2D communication according to an embodiment of the present disclosure;

FIG. 4 schematically illustrates a flow chart of a method of allocating resources for D2D communication according to another embodiment of the present disclosure;

FIG. 5 schematically illustrates a block diagram of an apparatus for allocating resources for D2D communication according to an embodiment of the present disclosure;

FIG. 6 schematically illustrates a block diagram of an apparatus for allocating resources for D2D communication according to another embodiment of the present disclosure;

FIG. 7 schematically illustrates the system rate on different number of D2D users according to an optimal allocation (OA) scheme, a greedy allocation (GA) scheme and a RA (Radom Allocation) scheme under constraint 1;

FIG. 8 schematically illustrates the system rate on different number of D2D users according to a GA scheme, a value table (VT) scheme and a RA scheme under constraint 2;

FIG. 9 schematically illustrates the system rate on different number of D2D users according to a VT scheme under constrain 3 in comparison to simulation results as illustrated in FIGS. 7 and 8;

FIG. 10 schematically illustrates the system rate on different number of D2D users according to a GA scheme, a greedy allocation with proportion fairness (GP) scheme and a RA scheme under constraint 1;

FIG. 11 schematically illustrates the system rate on different number of D2D users according to a GA scheme, a GP scheme and a RA scheme under constrain 2;

FIG. 12 schematically illustrates a channel rate distribution of D2D pair according to a GA scheme, a GP scheme and a RA scheme under constrain 1; and

FIG. 13 schematically illustrates a channel rate distribution of D2D pair according to a GA scheme, a GP scheme and a RA scheme under constrain 2.

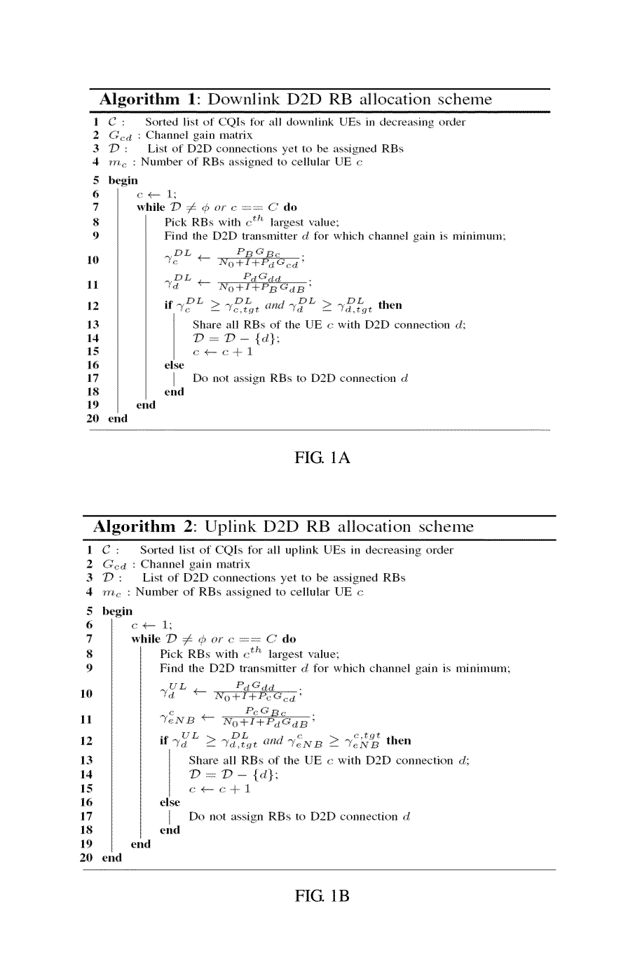

### DETAILED DESCRIPTION OF EMBODIMENTS

Hereinafter, a methods and apparatuses for allocating resources to D2D communication and network nodes therefor will be described in details through embodiments with reference to the accompanying drawings. It should be appreciated that these embodiments are presented only to enable those skilled in the art to better understand and implement the present disclosure, not intended to limit the scope of the present disclosure in any manner.

It should be first noted that this disclosure is illustrated in particular sequences for performing the steps of the methods. However, these methods are not necessarily performed strictly according to the illustrated sequences, and they can be performed in reverse sequence or simultaneously based on natures of respective method steps. Beside, the indefinite article “a/an” as used herein does not exclude a plurality of such steps, units, modules, devices, and objects, and etc.

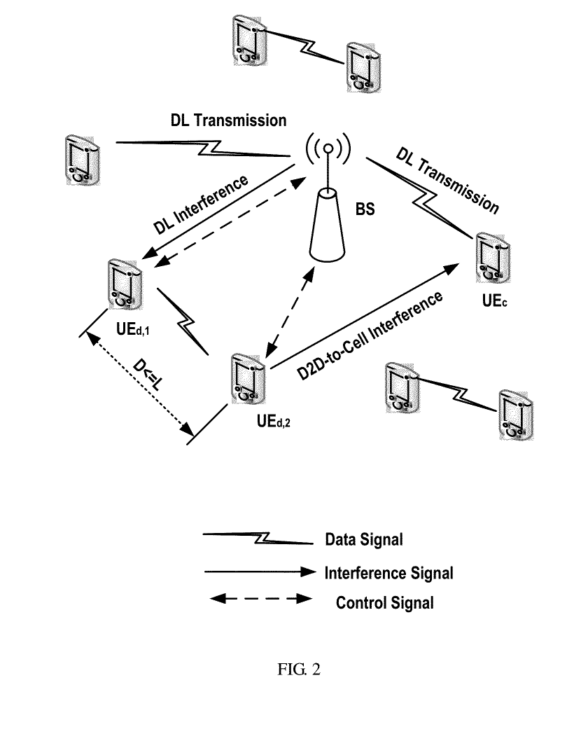

Before specifically describing embodiments of the present disclosure, the system model or the architecture of a system in which the present disclosure can be implemented will be firstly described with reference to FIG. 2, which schematically illustrates a system model of D2D communication underlying cellular networks in a case of downlink resource sharing.

As illustrated in FIG. 2, in the system model, there is a base station (BS) for serving for all users UE. Additionally, there are a plurality of traditional cellular users and a plurality of D2D users. The D2D users have direct data signal transmissions and the traditional cellular users transmit data signals to the BS in the system model. Each of the users is equipped with a single omnidirectional antenna. The D2D users are distributed uniformly in the cell and should satisfy the distance constraint of D2D communication (for example, the distance from a D2D transmitter to a D2D receiver is at most L). The traditional cellular users UE₁, UE₂, . . . , UE_{N} may be free to be at any location only if it complies with a uniform distribution.

The session setup of D2D communication requires the traffic fulfilling a certain criterion (e.g., data rate) so that the system would consider it as the potential D2D traffic. If both users in the pair are D2D capable and D2D communication offers higher throughput, the BS would set up a D2D bearer. However, the BS maintains detecting if users should be back to the cellular mode after the D2D connection setup succeeds. Further, the BS is the control center of the radio resource for both cellular and D2D communications.

FIG. 2 illustrates a scenario of downlink (DL) resource sharing. The D2D users UE_{d,1} and UE_{d,2} forms a D2D pair while UE_{c} is a traditional cellular user. The D2D users and the traditional cellular users will share the same radio resources. In the system model, UE_{d,1} is a D2D transmitter which will bring interference to cellular user UE_{c}, and that UE_{d,2} is a D2D receiver which will receive data signal transmitted from the D2D transmitter UE_{d,1}.

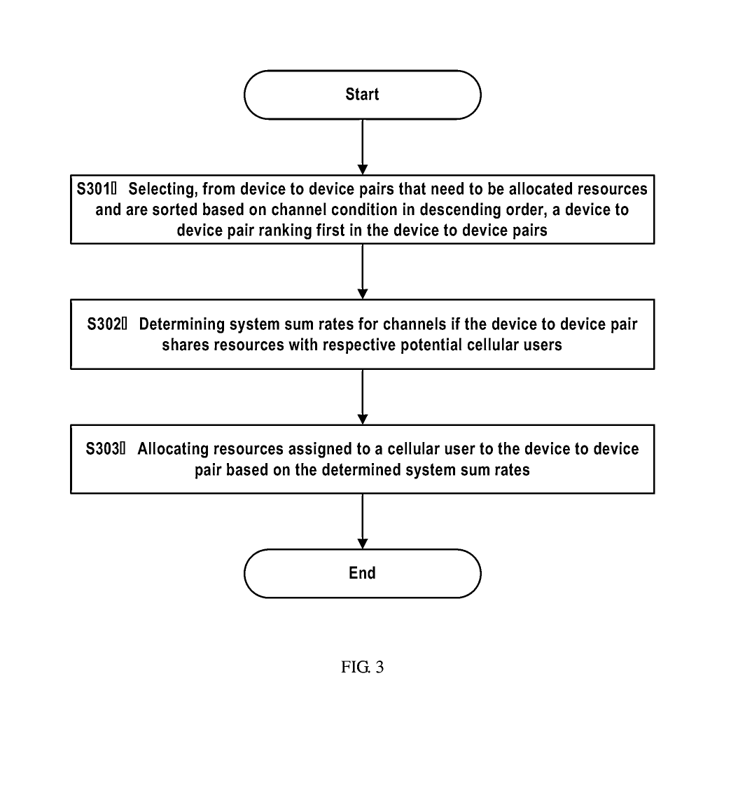

To improve the performance of the D2D communication and achieve the system optimization, there is provided a novel resource allocation scheme. The scheme considers a case that multiple D2D pairs share the same channel and is based on maximizing the system sum rate. Hereinafter, the resource allocation schemes as provided in the present disclosure will be described at length with reference to FIGS. 3 to 9.

Reference is made to FIG. 3, which schematically illustrates a flow chart of a method of allocating resources for D2D communication according to an embodiment of the present disclosure.

As illustrated, first at Step S301, a D2D pair is selected from D2D pairs that need to be allocated resources. In embodiments of the present disclosure, the device pairs that need to be allocated resources (RBs) are sorted based on channel condition in descending order and the D2D pair that ranks first in the D2D pairs is selected so as to allocate resource therefor.

The channel conditions for each of the D2D pairs will be estimated first. The channel condition may be indicated by any appropriate parameters. For example, it may be represented by channel rate at a current time interval, signal noise ratio (SNR) at the current time interval, path loss at the current time interval, path gain at the current time interval, etc. Determination of any one of these parameters is well-known to the skilled in the art and thus it will not be elaborated herein. Then, based on the estimated channel conditions, the D2D pairs are sorted in descending order. That is to say, a D2D pair with a better channel condition will be ranked higher, and a D2D pair with a worse channel condition will be ranked lower. After that, the D2D pair which is on top of the list may be selected as the candidate who will be allocated resources, or in other words, the D2D pair with the best channel condition (e.g. the largest channel rate) may be selected.

Next, at step S302, it determines system sum rates for channels if the D2D pair shares resources with respective potential cellular users. As described hereinbefore, in the system there are multiple cellular UEs, and each cellular user may be a potential cellular user that the D2D pair can share resources therewith. Therefore, it can determine the system sum rate for the channel if the D2D pair shares resources with each cellular user.

In an embodiment of the present disclosure, for each cellular user c of these potential cellular users, a channel rate if the D2D pair share resources with the cellular user is first determined. The channel rate R_{cd} may be determined by for example the following equation:

$${R}_{cd} = {log}_{2} [ 1 + \frac{{P}_{B} {h}_{BC}^{2}}{{\sum }_{j ∈ J + ( d )} {P}_{j} {h}_{jc}^{2} + {N}_{0}} ] + {\sum }_{j ∈ J + \{ d \}} {log}_{2} [ 1 + \frac{{P}_{j} {h}_{jj}^{2}}{{P}_{B} {h}_{Bj}^{2} + {\sum }_{{j}^{′} ∈ J + \{ d \} - \{ j \}} {P}_{j} {h}_{{j}^{′} j}^{2} + {N}_{0}} ] \qquad ( Equation 1 )$$

wherein P_{B} denotes the transmit power of the BS; h_{Bc} denotes the channel response from the BS to cellular user c; Pⱼ denotes the transmit power of cellular user j; h_{jc} denotes the channel response from cellular user j to the cellular user c; hⱼⱼ denotes the channel response from the transmitter to the receiver of device-to-device pair j; h_{Bj} denotes the channel response from the BS to cellular user j; P_{j′} denotes the transmit power of cellular user j′ and h_{j′j} denotes the channel response from cellular user j′ to cellular user j; N₀ denotes thermal noise power; I is a set of cellular users; and J is a set of D2D pairs that have shared resource with cellular user c.

Then the channel rates Rᵢ (i≠c) for other cellular users than the cellular user c is determined. Determination of the channel rate for a certain cellular user is well known in the art and thus will not be elaborated herein. The system sum rate if the D2D pair shares resources with the cellular user c can be determined based on the determined R_{cd} and the channel rates Rᵢ (i≠c) for the other cellular users. In an embodiment of the present disclosure, the system sum rate R can be determined by summing up the determined channel rate R_{cd} and channel rates Rᵢ (i≠c) for the other cellular users. That is to say, the system sum rate R can be represented by the following equation:

$$R = {R}_{cd} + {\sum }_{i = 1 \{ c \}} {R}_{i} \qquad ( Equation 2 )$$

In such a way, the system sum rates for the channels if the D2D pair shares resources with respective potential cellular users can be obtained.

Then, at step S303, resources assigned to a cellular user are allocated to the D2D pair based on the determined system sum rates. Particularly, in an embodiment of the present disclosure, a maximum value is found from the determined system sum rates, and resources assigned to a cellular user corresponding to the maximum value will be allocated to the D2D pair. That is to say, if the D2D pair share resources with a cellular user and it achieve a maximum system sum rate, then the resources assigned to the cellular user will be exactly allocated to the D2D pair, and more particularly to the D2D transmitter.

In another embodiment of the present disclosure, the D2D pair may be also allocated resources of one or more one cellular user. For example, resources assigned to K cellular users corresponding to the K number of maximum values in sum rates may be allocated to the D2D pair. Or alternatively, resources assigned to the cellular users corresponding to sum rate values higher than a predetermined threshold may be allocated the D2D pair.

The D2D pair that has been allocated resources (and that can not be allocated resource at current time interval) can be removed from the list of the D2D pairs that need to be allocated resources so as to update the list. The above-mentioned operations may be done on a new D2D pair which ranks first in the updated list to allocate resources for that D2D pair. The operations may be repeated until all D2D pairs have been allocated resources or no D2D pair needs to be allocated resources.

Therefore, according to embodiments of the present disclosure, the D2D pairs are allocated resources in descending order of channel condition, and the D2D pair with a better channel condition will be allocated resources earlier and the D2D pair with a worst channel condition will be allocated resources later. At the same time, it ensures that the resource sharing between the D2D pair and the cellular user which is designated to the D2D pair may achieve a maximum system sum rate. Thus, the embodiments may improve the performance of the D2D communication while achieving the system optimization.

Actually, the proposed scheme which has been described hereinbefore belongs to a greed algorithm (referred to as GA scheme hereafter); however, in the scheme, the resources will be always allocated to those D2D pairs with better channel conditions, and there might be a case that a D2D pair with a somewhat bad channel condition will always have a relative low performance and even will not be allocated resources. To tackle this problem, the inventors have further proposed another scheme, which may be called a greed algorithm with proportional fairness and referred to as GP scheme hereinafter.

In the GP scheme, it considers the fairness during resource allocation by taking the history condition regarding the previous results into account in sorting the D2D pairs. In an embodiment of the present disclosure, the channel condition is represented by a sorting weight or factor W_{d}^{T}. The sorting weight W_{d}^{T} can be determined based on channel quality at a current time interval and channel rate obtained at a previous time interval. In an exemplary implementation, the channel condition or the sorting weight W_{d}^{T} may be given for example by the following equation:

$${W}_{d}^{T} = \frac{{log}_{2} ( 1 + {P}_{d} {h}_{dd}^{2} / {N}_{0} )}{{\sum }_{t = 1}^{T - 1} {R}_{d}^{t}} \qquad ( Equation 3 )$$

wherein T denotes an index of current time interval; d denotes an index of the D2D pair; P_{d} denotes transmit power of the transmitter in the D2D pair; h_{dd} denotes a channel response from the transmitter to the receiver of the D2D pair; N₀ denotes the thermal noise power; R_{d}^{t} denotes channel rate of the D2D pair d at the previous time interval t.

After that, the operations as described with reference to steps S302 to S303 may be perfumed so as to allocate resources for the D2D pairs. That is to say, similar to the GA scheme, the GP scheme still focus maximizing the system sum rate but the history allocation results of each D2D pairs are considered in a sorting process so as to take the fairness into account. Accordingly, the undesired unfairness may be prevented effectively.

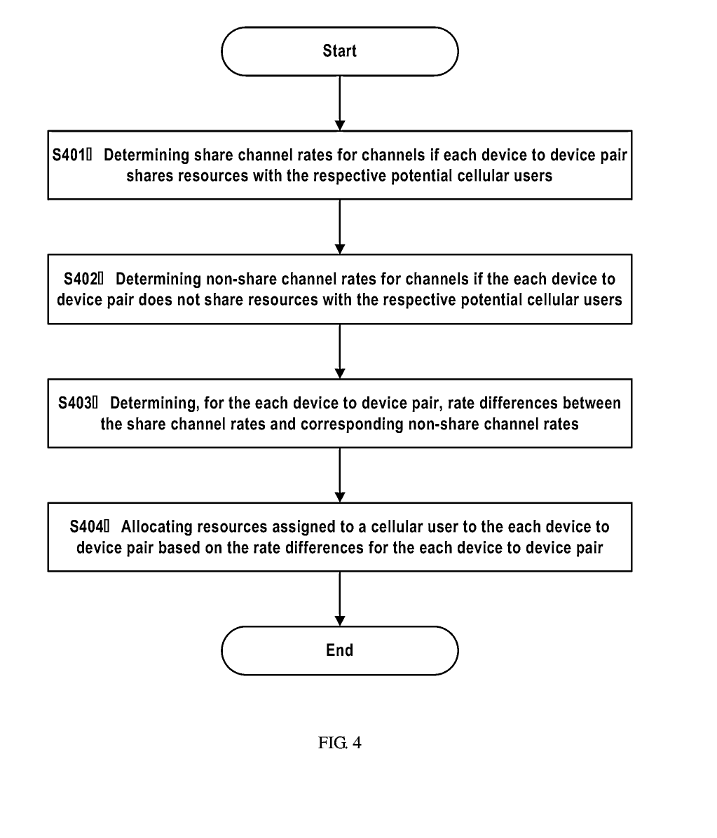

Besides, there is further provided another scheme for allocating resources for D2D communication, which may be performed based on value table (VT) algorithm. Hereinafter, detailed description will be made to that allocation scheme with reference to FIG. 4 which schematically illustrates a flow chart of a method of allocating resources for D2D communication according to another embodiment of the present disclosure.

As illustrated in FIG. 4, first at step S401, share channel rates for channels if each D2D pair shares resources with the respective potential cellular users are determined. In an embodiment of the present disclosure, the share channel rate R_{cd} if a D2D pair shares resources with a cellular user can be expressed for example by the following equation.

$${R}_{cd} = {log}_{2} [ 1 + \frac{{P}_{B} {h}_{BC}^{2}}{{P}_{d} {h}_{dc}^{2} + {N}_{0}} ] + {log}_{2} [ 1 + \frac{{P}_{d} {h}_{dd}^{2}}{{P}_{B} {h}_{Bd}^{2} + {N}_{0}} ] \qquad ( Equation 4 )$$

wherein P_{B} denotes the transmit power of the BS; h_{Bc} denotes the channel response from the BS to cellular user c; P_{d} denotes the transmit power of the D2D transmitter in the D2D pair; h_{dc} denotes the channel response from the D2D transmitter to the cellular user c; h_{dd} denotes the channel response from the D2D transmitter to the D2D receiver; h_{Bd} denotes the channel response from the BS to the D2D receiver. By calculating, for each D2D pair, share channel rates if it shares resource with each potential cellular user, it can obtain all values of the share channel rates for channels if each D2D pair shares resources with the respective potential cellular users.

Then, at step S402, non-share channel rates for channels if the each D2D pair does not share resources with the respective potential cellular users may be determined. In an embodiment of the present disclosure, a non-share channel rate R_{c} for a cellular user c if the D2D pair does not share resources with the cellular user c can be expressed for example by the following equation:

$${R}_{c} = {log}_{2} [ 1 + \frac{{P}_{B} {h}_{BC}^{2}}{{N}_{0}} ] \qquad ( Equation 5 )$$

After that, at step S403, for the each D2D pair, rate differences between the share channel rates and the corresponding non-share channel rates are determined. That is to say, the increments or gains of channel rate because of each D2D pair sharing cellular resources are determined, which can be expressed, for example, by the following equation.

V_{cd}=max(R_{cd}−Rc,0). (Equation 6)

That is to say, if the rate difference is less then zero, the V_{cd} can be replaced with zero; however, this is illustrated for an illustration purpose and the present disclosure is not limited thereto. Actually, it can also use the direct difference between the two rates as the rate difference.

Next, at step S404, resources assigned to a cellular user are allocated to a D2D pair based on the rate differences for the each D2D pair.

For example, for each D2D pair, a maximum difference value may be found from rate differences regarding the D2D pair and cellular users, then the resources assigned to a cellular user corresponding to the maximum difference value.

In another embodiment of the present disclosure, a table is formed by using these rate differences, an element in the table represents a rate difference corresponding to a D2D pair and a potential cellular user. An example table is schematically illustrated in Table 1 for an illustration purpose.

TABLE 1
Table for channel rate difference.

| | 1 | 2 | . . . | n | . . . | N |
|---|---|---|---|---|---|---|
| 1 | V₁₁ | V₁₂ | . . . | V₁ₙ | . . . | V_{1N} |
| 2 | V₂₁ | V₂₂ | . . . | V₂ₙ | . . . | V_{2N} |
| . . . | . . . | . . . | . . . | . . . | . . . | . . . |
| m | Vₘ₁ | Vₘ₂ | . . . | Vₘₙ | . . . | V_{mN} |
| . . . | . . . | . . . | . . . | . . . | . . . | . . . |
| M | V_{M1} | V_{M2} | . . . | V_{Mn} | . . . | V_{MN} |

As listed in Table 1, element Vₘₙ in m-th row and in n-th column is a channel rate gain if the m-th D2D pair shares resource with the n-th cellular user. In such a case, resources allocation may be performed by looking up data in the table. In an embodiment of the present disclosure, a maximum value is found from the table, then resources assigned to a cellular user corresponding to the maximum value is allocated to a D2D pair corresponding to the maximum value. After that, elements of a row and a column in which the maximum value is located may be deleted so as to allocate resource of one cellular exactly to one D2D pair. This is because above-mentioned equations 4 and 5 are given under a condition that only one D2D pair can share the same sub carriers with one cellular user, one D2D pair can only use one cellular user's resources.

However it can be appreciated that equations 4 and 5 are given for an illustration purpose, and for conditions that more than one D2D pairs can share the same sub-carriers with one cellular and/or more than one cellular user's resources can be shared by one D2D pair, the skilled in the art may construct other suitable equations from teaching provided herein. And it is also appreciated that the resource allocation can also be performed for the above-conditions through slightly modifying the allocation process provided herein so to adapt to these conditions.

Additionally, there is also provided an apparatus for allocating resources for D2D communication, which will be described hereinafter with reference to FIG. 5.

As illustrated in FIG. 5, apparatus 500 may comprise communication pair selection module 501, sum rate determination module 502, and resource allocation module 503. The communication pair selection module 501 may be configured to select, from device-to-device pairs that need to be allocated resources and are sorted based on channel condition in descending order, a device-to-device pair ranking first in the device-to-device pairs. The sum rate determination module 502 may be configured to determine system sum rates for channels if the device-to-device pair shares resources with respective potential cellular users. The resource allocation module 503 may be configured to allocate resources assigned to a cellular user to the device-to-device pair based on the determined system sum rates.

In an embodiment of the present disclosure, the sum rate determination module 502 may be further configured to, for each cellular user of the respective potential cellular users: determine a channel rate if the device-to-device pair share resources with the each cellular user; and sum up the determined channel rate and channel rates for other cellular users than the each cellular user, as the system sum rate if the device-to-device pair shares resources with the each cellular user.

In another embodiment of the present disclosure, the resource allocation module may be further configured to: obtain a maximum value in the determined system sum rates; and allocate resources assigned to a cellular user corresponding to a maximum value in the system sum rates to the device-to-device pair.

In a further embodiment of the present disclosure, the channel condition may be represented by any one of channel rate at a current time interval; signal noise ratio at the current time interval; path loss at the current time interval; and path gain at the current time interval.

In a still further embodiment of the present disclosure, wherein the channel condition may be represented by channel quality at a current time interval and channel rate obtained at a previous time interval.

In a yet further embodiment of the present disclosure, the channel condition is represented by a factor W_{d}^{T}:

$${W}_{d}^{T} = \frac{{log}_{2} ( 1 + {P}_{d} {h}_{dd}^{2} / {N}_{0} )}{{\sum }_{t = 1}^{T - 1} {R}_{d}^{t}}$$

wherein T denotes an index of current time interval; d denotes an index of the device-to-device pair; P_{d} denotes transmit power of a transmitter in the device-to-device pair; h_{dd} denotes a channel response from the transmitter to the receiver in the device-to-device pair; N₀ denotes the thermal noise power; R_{d}^{t} denotes channel rate of the device-to-device pair d at the previous time interval t.

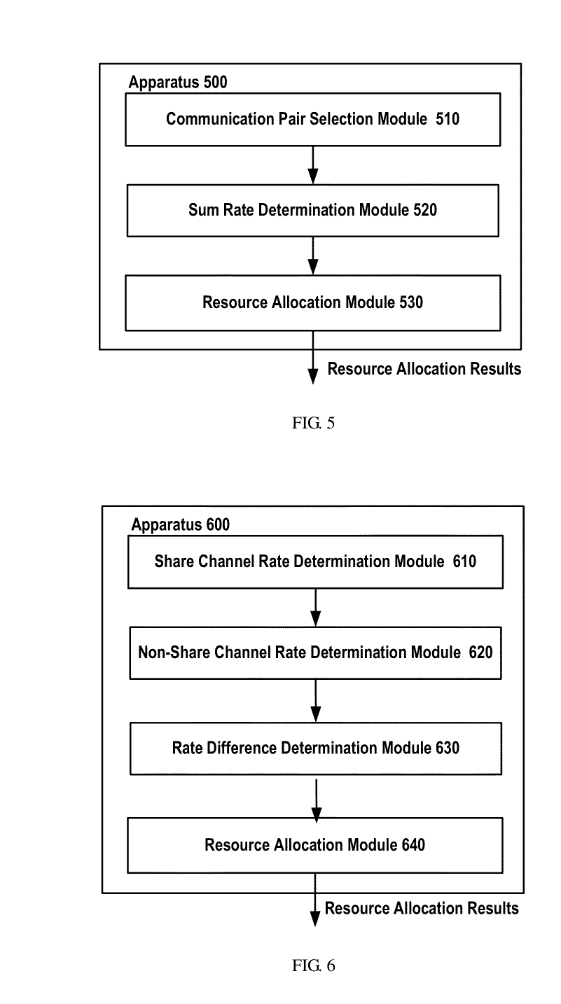

Next reference will be further made to FIG. 6 to describe another apparatus for allocating resources for device-to-device communication as provided herein. As illustrated in FIG. 6, apparatus 600 may comprise share channel rate determination module 601, non-share channel rate determination module 602, rate difference determination module 603, and resource allocation unit 604. The share channel rate determination module 601 may be configured to determine share channel rates for channels if each device-to-device pair shares resources with the respective potential cellular users. The non-share channel rate determination module 602 may be configured to determine non-share channel rates for channels if the each device-to-device pair does not share resources with the respective potential cellular users. The rate difference determination module 603 may be configured to determine, for the each device-to-device pair, rate differences between the share channel rates and the corresponding non-share channel rates. The resource allocation module 604 may be configured to allocate resources assigned to a cellular user to a device-to-device pair based on the rate differences for the each device-to-device pair.

In an embodiment of the present disclosure, the rate differences for the each device-to-device pair may form a table, an element of which represents a rate difference corresponding to a device-to-device pair and a potential cellular user, and wherein the resource allocation module is configured to perform the resource allocation by looking up data in the table.

In another embodiment of the present disclosure, the resource allocation module 604 may be further configured to find a maximum value in the table; allocate resources assigned to a cellular user corresponding to the maximum value to a device-to-device pair corresponding to the maximum value; and delete elements of a row and a column in which the maximum value is located.

In addition, there are also provided a network node comprising an apparatus 500 as described with reference to FIG. 5 and another network node comprising an apparatus 600 as described with reference to FIG. 6.

It should be noted that operations of respective modules as comprised in the apparatus 500, 600 and the network node substantially correspond to respective method steps as previously described with reference to FIGS. 3 to 4. Therefore, for details about the operations of these modules, please refer to the previous descriptions of the methods of the present disclosure with reference FIGS. 3 to 4.

Additionally, the inventors have carried out simulations on the technical solutions as provided in the present disclosure and random allocation scheme in prior art. All simulations are made to the DL transmission; and in these simulations, the following assumptions for parameters as listed in Table 2 are used.

TABLE 2
Parameter Assumptions

| Parameter | Assumptions |
|---|---|
| Cellular | Isolated cell, 1-sector |
| System Area | UEs are distributed in a hexagonal cell |
| | with 350 m radius |
| Noise spectral density | −174 dBm/Hz |
| Sub-carrier bandwidth | 15 kHz |
| Noise figure | BS: 5 dB |
| | UE: 9 dB |
| Antenna gains and patterns | BS: 14 dBi |
| | UE: Omnidirectional 0 dBi |
| Cluster radios | 25 m |
| Transmit power | BS: 46 dBm |
| | UE: 20 dBm (without power control) |
| The number of cellular users | 5 |
| The number of D2D users | 2~16 |

According the resource allocation scheme as proposed in the present disclosure, it can allow multiple D2D pairs to share on the same channel and/or allow one D2D pair to share one multiple channels. Therefore, in these simulations, various schemes are simulated under the following constrains respectively:

Constrain 1: More than one D2D pairs may share the same sub-carriers with one cellular and one D2D pair can only use one cellular user's recourses for transmitting.

Constrain 2: Only one D2D pairs may share the same sub-carriers with one cellular and one D2D pair can only use one cellular user's recourses for transmitting.

Constrain 3: Only one D2D pairs may share the same sub-carriers with one cellular and one D2D pair can use more than one cellular user's recourses for transmitting.

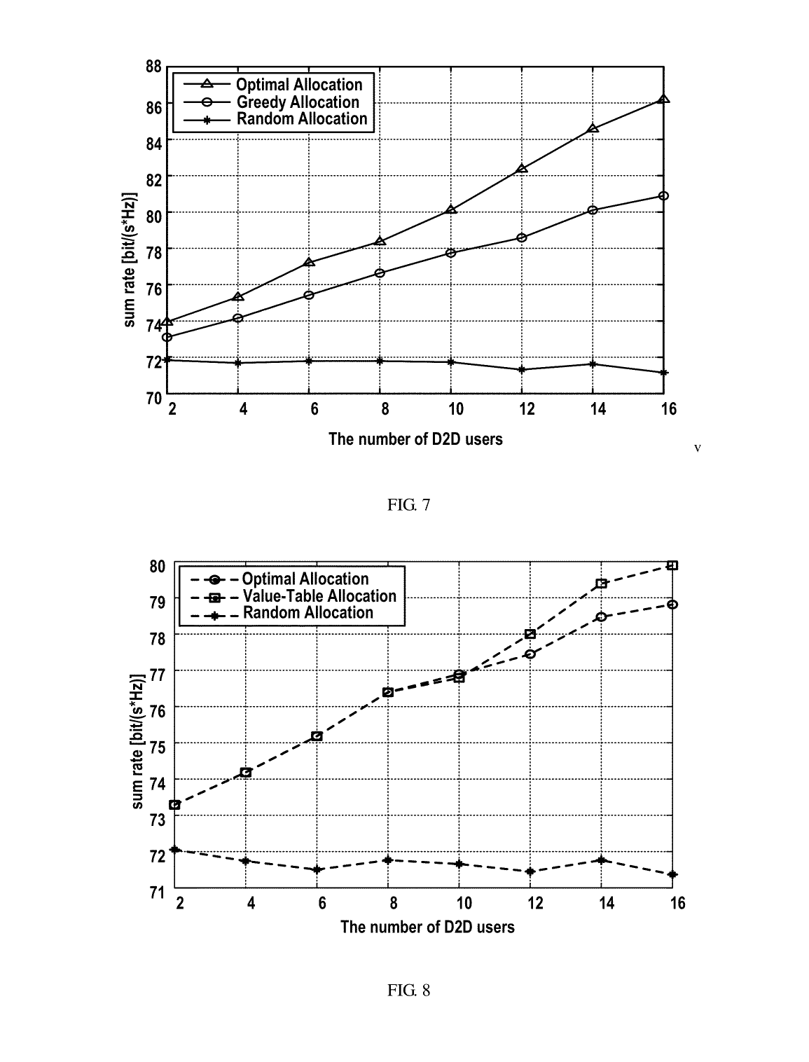

Reference is made to FIG. 7, which schematically illustrates the system rate on different number of D2D users according to an optimal allocation (OA) scheme, a greedy allocation (GA) scheme and a random allocation (RA) scheme under constraint 1. The OA scheme is an exhaustive scheme for achieving a global optimization by listing all possible resource allocation manners and choosing therefrom one that maximizes the system rate as final allocation result, which is an non-deterministic polynomial NP-hard way and will consume a great number of computation resources. In practice, the OA scheme will not be adopted due to an extreme amount of computations; however, it is simulated herein so as to compare with the schemes as provided in the present disclosure. From FIG. 7, it is clear that both the OA scheme is not much superior to the GA scheme whereas the GA scheme is much superior to the random allocation algorithm. Additionally, it can be seen that the sum rate rises continuously with increasing of the number of users since the co-channel interference is much lower then the user's received power.

FIG. 8 schematically illustrates the system rate on different number of D2D users according to the GA scheme, a Value Table (VT) scheme and the RA scheme under scheme under constraint 2. The simulation results show that the increase rate of the system sum rate slows down when the number of D2D users is more than 10, which is because the constraint 2 restricts one cellular user's resource to be assigned to multiple pairs. However, with increasing of the number of the D2D users, the probability that users with better channel condition are assigned resources also increase, which can in turn lead to increasing of the system sum rate. This can be considered as the effect of multi-user diversity.

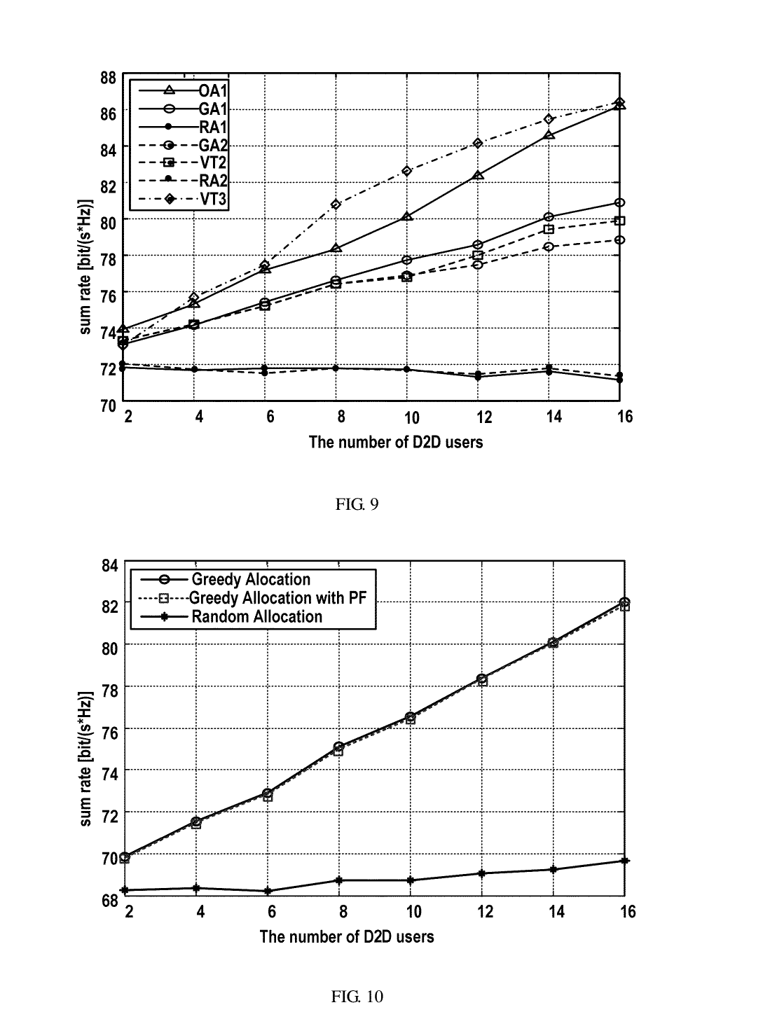

Next, referring to FIG. 9, which schematically illustrates the system rate on different number of D2D users according to VT scheme under constrain 3 in comparison to simulation results as illustrated in FIGS. 7 and 8. FIG. 9 shows that the VT scheme under constrain 3 can achieve the best performance among all the schemes since constrain 3 allows one D2D pair to share more than one cellular users' resources.

FIG. 10 schematically illustrates the system rate on different number of D2D users according to the GA scheme, the GP scheme and the RA scheme under constraint 1. Form these curves, it can be seen that the GA scheme and the GP scheme under constrain 1 may have similar performance, which means the fairness consideration does not compromise the system capacity under constrain 1.

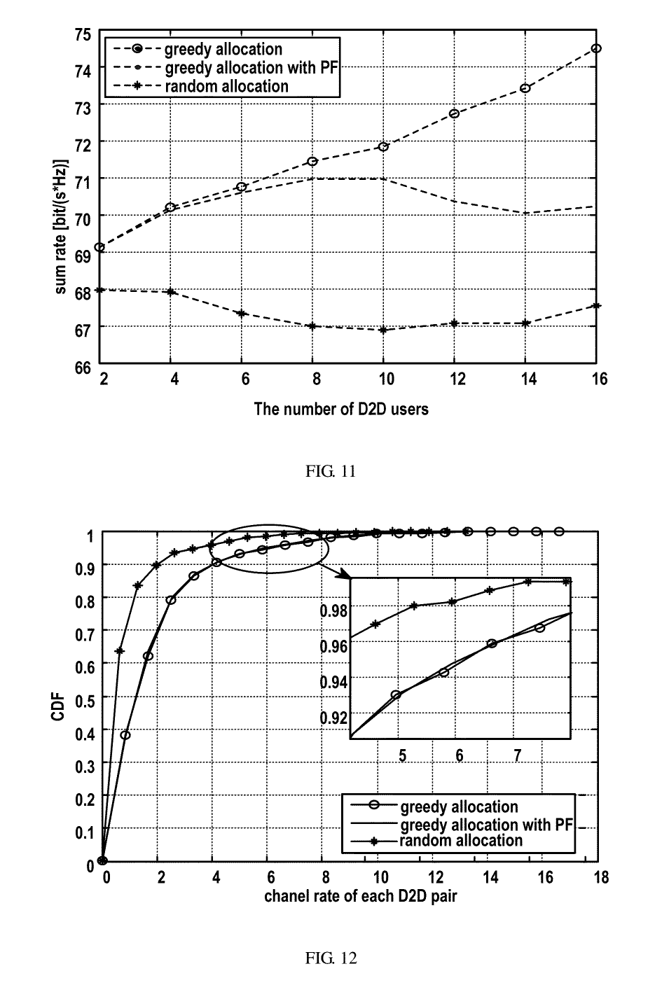

Reference is further made to FIG. 11, which schematically illustrates the system rate on different number of D2D users according to the GA scheme, the GP scheme, and the RA scheme under constrain 2. As illustrated, the sum rate increase with the increasing of the number of D2D users but it begins to decrease when the number of D2D pairs is larger than the number of resource units. This is because constrain 2 defines that only one pair can reuse one resource unit, which limits the increasing of the sum rate.

FIG. 12 schematically illustrates channel rate distribution of D2D pair according to the GA scheme, the GP scheme and the RA scheme under constrain 1 and the number of the D2D users is 16. From this figure, it can be seen that the GA scheme and the GP scheme have also similar results under constrain. This indicates that the introduction of the fairness does not contribute to the system performance since constrain 1 allows all pairs to be assigned frequency resources.

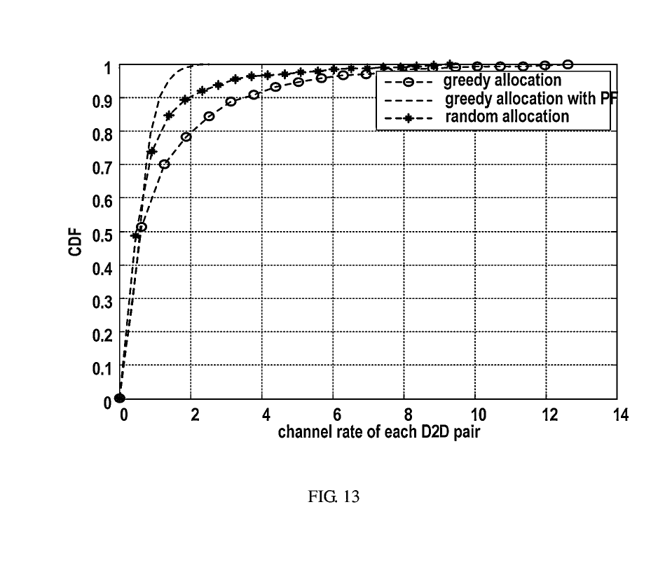

Further referring to FIG. 13, it schematically illustrates channel rate distribution of D2D pair according to GA scheme, GP scheme, and RA scheme under constrain 2. It is clear that the channel rate distribution using GP scheme under constrain 2 is quite steep, which means the scheme is the fairest one among the three allocations.

Although the simulation has been made to the downlink transmission, it can be contemplated that the results in uplink transmission are similar to those in downlink transmission.

By far, the present disclosure has been described with reference to the accompanying drawings through particular preferred embodiments. However, it should be noted that the present disclosure is not limited to the illustrated and provided particular embodiments, but various modification may be made within the scope of the present disclosure.

Further, the embodiments of the present disclosure can be implemented in software, hardware or the combination thereof. The hardware part can be implemented by a special logic; the software part can be stored in a memory and executed by a proper instruction execution system such as a microprocessor or a dedicated designed hardware. Those normally skilled in the art may appreciate that the above method and system can be implemented with a computer-executable instructions and/or control codes contained in the processor, for example, such codes provided on a bearer medium such as a magnetic disk, CD, or DVD-ROM, or a programmable memory such as a read-only memory (firmware) or a data bearer such as an optical or electronic signal bearer. The apparatus and its components in the present embodiments may be implemented by hardware circuitry, for example a very large scale integrated circuit or gate array, a semiconductor such as logical chip or transistor, or a programmable hardware device such as a field-programmable gate array, or a programmable logical device, or implemented by software executed by various kinds of processors, or implemented by combination of the above hardware circuitry and software, for example by firmware.

Though the present disclosure has been described with reference to the currently considered embodiments, it should be appreciated that the present disclosure is not limited the disclosed embodiments. On the contrary, the present disclosure is intended to cover various modifications and equivalent arrangements falling within in the spirit and scope of the appended claims. The scope of the appended claims is accorded with the broadest explanations and covers all such modifications and equivalent structures and functions.

1. A method of allocating resources for device-to-device communication, comprising:
selecting, from device-to-device pairs that need to be allocated resources and are sorted based on channel condition in descending order, a device-to-device pair ranking first in the device-to-device pairs;
determining system sum rates for channels if the device-to-device pair shares resources with respective potential cellular users; and
allocating resources assigned to a cellular user to the device-to-device pair based on the determined system sum rates.

2. The method according to claim 1, wherein the determining system sum rates comprises, for each cellular user of the respective potential cellular users:
determining a channel rate if the device-to-device pair share resources with the each cellular user; and
summing up the determined channel rate and channel rates for other cellular users than the each cellular user, as the system sum rate if the device-to-device pair shares resources with the each cellular user.

3. The method according to claim 1, wherein the allocating resources comprises:
obtaining a maximum value in the determined system sum rates; and
allocating resources assigned to a cellular user corresponding to the maximum value to the device-to-device pair.

4. The method according to claim 1, wherein the channel condition is represented by any one of:
channel rate at a current time interval;
signal noise ratio at the current time interval;
path loss at the current time interval; and
path gain at the current time interval.

5. The method according to claim 1, wherein the channel condition is represented by channel quality at a current time interval and channel rate obtained at a previous time interval.

6. The method according to claim 5, wherein the channel condition is represented by a factor W_{d}^{T}:
$${W}_{d}^{T} = \frac{{log}_{2} ( 1 + {P}_{d} {h}_{dd}^{2} / {N}_{0} )}{{\sum }_{t = 1}^{T - 1} {R}_{d}^{t}}$$
wherein T denotes an index of current time interval; d denotes an index of the device-to-device pair; P_{d} denotes transmit power of a transmitter in the device-to-device pair; h_{dd} denotes a channel response from the transmitter to the receiver of the device-to-device pair; N₀ denotes the thermal noise power; R_{d}^{t} denotes a channel rate of the device-to-device pair d at the previous time interval t.

7. A method of allocating resources for device-to-device communication, comprising:
determining share channel rates for channels if each device-to-device pair shares resources with the respective potential cellular users;
determining non-share channel rates for channels if the each device-to-device pair does not share resources with the respective potential cellular users;
determining, for the each device-to-device pair, rate differences between the share channel rates and the non-share channel rates corresponding thereto; and
allocating resources assigned to a cellular user to a device-to-device pair based on the rate differences for the each device-to-device pair.

8. The method according to claim 7, wherein the rate differences for the each device-to-device pair forms a table, an element of which represents a rate difference corresponding to a device-to-device pair and a potential cellular user, and wherein the allocating resources is performed by looking up data in the table.

9. The method according to claim 8, wherein the allocating resources comprises
finding a maximum value in the table;
allocating resources assigned to a cellular user corresponding to the maximum value to a device-to-device pair corresponding to the maximum value; and
deleting elements of a row and a column in which the maximum value is located.

10. Apparatus for allocating resources for device-to-device communication, comprising:
communication pair selection module configured to select, from device-to-device pairs that need to be allocated resources and are sorted based on channel condition in descending order, a device-to-device pair ranking first in the device-to-device pairs;
sum rate determination module configured to determine system sum rates for channels if the device-to-device pair shares resources with respective potential cellular users; and
resource allocation module configured to allocate resources assigned to a cellular user to the device-to-device pair based on the determined system sum rates.

11. The apparatus according to claim 10, wherein the sum rate determination module is further configured to, for each cellular user of the respective potential cellular users:
determine a channel rate if the device-to-device pair share resources with the each cellular user; and
sum up the determined channel rate and channel rates for other cellular users than the each cellular user, as the system sum rate if the device-to-device pair shares resources with the each cellular user.

12. The apparatus according to claim 10, wherein the resource allocation module is further configured to:
obtain a maximum value in the determined system sum rates; and
allocate resources assigned to a cellular user corresponding to a maximum value to the device-to-device pair.

13. The apparatus according to claim 10, wherein the channel condition is represented by any one of:
channel rate at a current time interval;
signal noise ratio at the current time interval;
path loss at the current time interval; and
path gain at the current time interval.

14. The apparatus according to claim 10, wherein the channel condition is represented by channel quality at a current time interval and channel rate obtained at a previous time interval.

15. The apparatus according to claim 14, wherein the channel condition is represented by a factor W_{d}^{T}:
$${W}_{d}^{T} = \frac{{log}_{2} ( 1 + {P}_{d} {h}_{dd}^{2} / {N}_{0} )}{{\sum }_{t = 1}^{T - 1} {R}_{d}^{t}}$$
wherein T denotes an index of current time interval; d denotes an index of the device-to-device pair; P_{d} denotes transmit power of a transmitter in the device-to-device pair; h_{dd} denotes a channel response from the transmitter to the receiver in the device-to-device pair; N₀ denotes the thermal noise power; R_{d}^{t} denotes channel rate of the device-to-device pair d at the previous time interval t.

16. An apparatus for allocating resources for device-to-device communication, comprising:
share channel rate determination module configured to determine share channel rates for channels if each device-to-device pair shares resources with the respective potential cellular users;
non-share channel rate determination module configured to determine non-share channel rates for channels if the each device-to-device pair does not share resources with the respective potential cellular users;
rate difference determination module configured to determine, for the each device-to-device pair, rate differences between the share channel rates and the corresponding non-share channel rates; and
resource allocation module, configured to allocate resources assigned to a cellular user to a device-to-device pair based on the rate differences for the each device-to-device pair.

17. The apparatus according to claim 16, wherein the rate differences for the each device-to-device pair forms a table, an element of which represents a rate difference corresponding to a device-to-device pair and a potential cellular user, and wherein the resource allocation module is configured to perform the resource allocation by looking up data in the table.

18. The apparatus according to claim 17, wherein the resource allocation module is further configured to
find a maximum value in the table;
allocate resources assigned to a cellular user corresponding to the maximum value to a device-to-device pair corresponding to the maximum value; and
delete elements of a row and a column in which the maximum value is located.

19. (canceled)

20. (canceled)
